(19) United States
(12) Patent Application Publication
(10) Pub. No.: US 2007/0069651 A1
(43) Pub. Date: Mar. 29, 2007

(54) Lamp comprising a cap with a key function and a method for manufacturing such lamp

(75) Inventors: Johannes Antonius Adrianus Maria Van Heeswijk, Eindhoven (NL); Klaus Eberhard Meinecke, Aachen (DE); Johann-Josef Kohl, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKI PHILIPS ELECTRONICS N.V., Eindhoven (NL)

(21) Appl. No.: 10/577,112

(22) PCT Filed: Oct. 19, 2004
(86) PCT No.: PCT/IB04/52141

§ 371 Date: Apr. 25, 2006

(30) Foreign Application Priority Data
Oct. 30, 2003 (EP) 03104023.1

(51) Int. Cl. H01J 61/36

(52) U.S. Cl. 313/624

(57) ABSTRACT

A lamp comprising a burner (1) and a cap (2) to connect the lamp with a lampholder. The shape of the cap (2) determines the type of lampholder to which the lamp can be connected. Said shape of the cap (2) is established after the burner (1) and the cap (2) of the lamp are assembled. Preferably, said shape of the cap (2) is established by breaking away a break away part (8) provided at the cap (2).

The invention is related to a lamp comprising a burner and a cap to connect the lamp with a lampholder, whereby the shape of the cap determines the type of lampholder to which the lamp can be connected, i.e. the cap has a key function. The expression ‘type of lampholder’ means a lampholder having a certain shape, so that only lamps intended for to that lampholder will fit in it. A certain type of lampholder may belong to a certain application of the lamp.

In general the burner comprises a bulb of transparent glass containing means for generating light. The cap can be made of metal and/or plastic material and comprises means for being fixed in the lampholder. The burner and the cap may be connected to each other by glue or a similar intermediary material, and/or by a clamping engagement.

Such lamp is known, for example for use as head lamp in a vehicle. The cap of the lamp does only fit in a certain type of lampholder having a predetermined shape, whereby the cap and that type of lampholder engage with each other. Usually, the lamp can be fixed in the lampholder in only one position, whereby the lamp has an exact predetermined position with respect to a reflector in front of the lamp, in order to make sure that the light radiation of the lamp is shining with a proper beam in the desired direction. For example, the lamp can be fixed in the lampholder by means of a bayonet connection or by clamping by means of a spring or the like, as is often used for fixing a head lamp of a car.

Normally, the cap of the lamp is provided with electric contacts for supplying electric power to the burner of the lamp. Thereby the electric contacts of the cap and corresponding contacts at the lampholder may engage automatically when the lamp is fixed in the lampholder. In another embodiment, the electric contacts of the cap are connected to the electric power source after the lamp is mounted in the lampholder. Thereby a separate electric power connection device with corresponding contacts can be attached to the contacts of the cap when the lamp is fixed in the lampholder.

For several reasons it can be important that a lamp only fits in one predetermined type, or some predetermined types of lampholder. Especially for lamps applied in the automotive field, the presence of certain specific properties of the lamp can be important for safety reasons. For example, it may be required that a lamp for a certain application, or purpose, must be a first quality lamp, having very strict specifications. And for another application, the same kind of lamp may have a less quality, for example having a larger variation in certain specifications.

In case a lamp must comply with strict specifications, the lamp can be produced by making use of a high quality production system in order to make sure that the strict specifications are met. However, it is often more efficient to make use of a cheaper production system or production method, and to test the lamps after production. Lamps not complying with the specifications can then be rejected, so that the required quality level can be maintained. The specifications can be related to the dimensions of the lamp, whereby the location of the light generation and/or the location of reflector means with respect to the cap, and therewith to the lampholder, may be critical. The specifications may also be related to the colour of the generated light or to other properties of the generated light.

The object of the invention is to provide an efficient production of lamps for different applications and therefore having different specifications, whereby the shape of the cap of the lamp determines the application of the lamp.

In order to accomplish that objective, said shape of the cap is established after the burner and the cap of the lamp are assembled, i.e. after the lamp as such is produced. After assembling the burner and the cap, the lamp can be tested to check its properties. Thereby the critical dimensions of the lamp can be measured and, if necessary for determining the quality of the lamp, the lamp can be connected to an electric power source to measure its functioning. Depending on the results of the testing and measuring, the cap of the lamp can be provided with the specific shape belonging to said results. Because the cap is already connected to the burner, it is not possible that a cap with e certain shape is attached to a burner not belonging to that cap.

Said shaping of the cap can be established by a material removing operation such as grinding, or by a material deforming operation. In one preferred embodiment, said shape of the cap is established by breaking away, or not, on or more break away parts provided at the cap. The use of break away parts is known, and is an appropriate means for providing a component with a predetermined shape, different from the original shape of that component.

Preferably, the cap comprises a row of break away parts, whereby one or more break away parts of the row may be removed. Thereby the final shape of the cap can be chosen from a number of predetermined shapes.

The lampholder, to which the lamp will be connected, can have one or more protrusions creating a counter part of the key of the lamp. In case the lampholder has a protrusion at a location where the cap of a lamp has a break away part that is not broken away—when the lamp and the lampholder would be connected—then the lamp does not fit in that lampholder. However, in case such break away part is removed, the lamp will fit in that lampholder. Of course, the lamp will also fit in a lampholder without said protrusion, so that it is possible to have a lampholder in which caps having different shapes will fit.

In one preferred embodiment, two break away parts are removed, whereby two separate recesses are created. In case of a row of break away parts, two not bordering parts can be broken away to create the two separate recesses. The same can be achieved by applying break away parts not bordering to each other.

In one preferred embodiment the break away parts are present in a radially extending flange of the cap. Such flange may abut a corresponding flat portion of the lampholder, which flat portion may be provided with one or more protrusions filling the recess or recesses in the flange of the cap caused by the absence of the break away part or parts.

The invention furthermore relates to a method for manufacturing a lamp comprising a burner and a cap to connect the lamp with a lampholder, whereby the shape of the cap determines the type of lampholder to which the lamp can be connected, and whereby the shape of the cap is established after the burner and the cap are assembled to form the lamp.

In one preferred embodiment, said shape of the cap is established by breaking away a part of the cap, whereby that part was connected to the remainder of the cap by a relative weak connection. Preferably, said shape to be established depends on the results of a testing procedure of the lamp, whereby the possible application or applications of the lamp is determined.

The invention will now be elucidated by means of a description of an embodiment of a head lamp for a vehicle, in which reference is made to the drawing, in which:

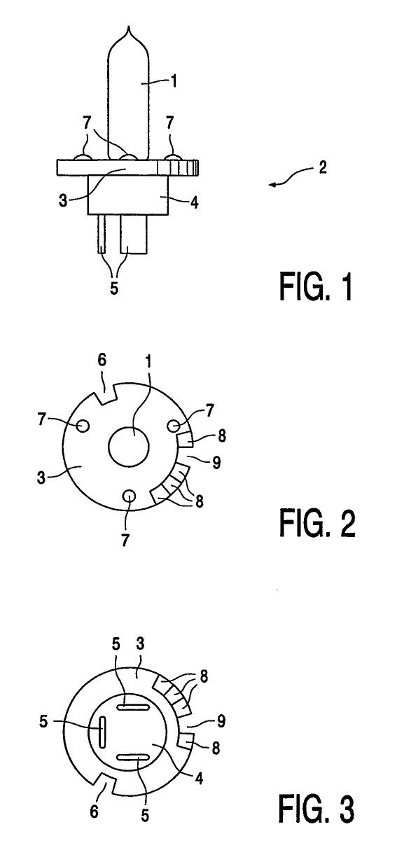

FIG. 1 is a side view of the lamp;

FIG. 2 is a top view of the lamp shown in FIG. 1; and

FIG. 3 is a bottom view of the lamp shown in FIG. 1.

The figures are only schematic representations of the described embodiment of the lamp. Although the invention can be applied with any kind of lamp, such as a gas discharge lamp whereby the light is generated in a gas between two electrodes, the described embodiment is a filament lamp.

FIG. 1 shows a burner 1 and a cap 2. The burner 1 comprises a bulb of glass containing two filaments (not shown) for generating light. Electric power can be supplied to each of the filaments, so that alternatively two different patterns of radiation of light can be generated, as is usual with head lamps of a vehicle.

The cap 2 of the lamp is made of plastic material and comprises a radially extending flange 3, a central portion 4 and three electric contacts 5. The flange 3 is provided with a recess 6, and the upper side of the flange 3 is provided with three protrusions 7. The burner 1 and the cap 2 are connected to each other by clamping elements of the cap 2, which elements (not shown in the drawing) engage the burner 1 and keep the burner 1 in the correct position with respect to the cap 2.

The lamp can be fixed in a lampholder (not shown in the drawing) located in the center of a reflector, so that the light radiation from the burner 1 is reflected by the reflector and converted into a beam. When fixing the lamp, the burner 1 is put through a bore in the lampholder and the flange 3 abuts against a surface near the edge of that bore. Thereby, the three protrusions 7 engage with three corresponding recesses in said surface, so that an exact predetermined positioning of the lamp with respect to the lampholder is achieved.

The lamp can be fixed in the lampholder in only one position, because of the presence of the recess 6 of the flange 3 and a corresponding protrusion of the lampholder. The lamp is fixed in the lampholder by means of a spring (not shown in the drawing) pushing the flange 3 against said surface of the lampholder. After the lamp is fixed, the electric contacts 5 can be connected to an electric power connection device (not shown in the drawing), so that electric power can be supplied through guiding means in the central portion 4 of the cap 2 to the filaments in the bulb of the burner 1.

As shown in FIGS. 2 and 3, the flange 3 furthermore comprises a row of so called break away parts 8. One break away part is broken away, so that a recess 9 is created. A break away part 8 is a piece of the flange 3, which piece is connected with the remaining portion of said flange 3 through a relative weak connection. By means of a special tool one or more break away parts 8 can be removed from the flange 3, creating a certain shape of the flange 3. The certain shape is a key determining the type of lampholder, or the types of lampholder, in which the lamp can be fixed.

A lampholder in which the certain lamp can be fixed has a protrusion that reaches in the recess 9 of the flange 3 of the cap 2 of that certain lamp. Only lamps having that key, i.e. having the recess 9 at that specific location of the flange 3, will fit in that lampholder.

The key of the lamp is created after the lamp is assembled, i.e. after the burner 1 and the cap 2 are connected with each other, and after the lamp is tested. In case the lamp complies with the specification corresponding to a certain application of the lamp, the concerning break away part 8 (or parts 8) will be removed, so that the key of the lamp is created. The lampholder for lamps of that certain application has a protrusion that reaches in the recess 9 created by the removal of the break away part, so that only lamps without that break away part will fit in the lampholder.

In case the lamp does not comply with the specification corresponding to said certain application, but the lamp can be used for another application, another break away part 8 will be removed, so that the lamp will fit in another type of lampholder. In case of a non critical application of the lamp, a lampholder without any such protrusion can be used, so that all lamps will fit in that lampholder.

It will be clear that by making use of the described way of providing a lamp with a key many different predestinations of lamps are possible, based on the testing of the assembled lamp.

The embodiment as described above is merely an example of the lamp and the method to manufacture the lamp; a great many other embodiments are possible.

1. A lamp comprising a burner (1) and a cap (2) to connect the lamp with a lampholder, whereby the shape of the cap (2) determines the type of lampholder to which the lamp can be connected, characterized in that said shape of the cap (2) is established after the burner (1) and the cap (2) of the lamp are assembled.

2. A lamp as claimed in claim 1, characterized in that said shape of the cap (2) is established by breaking away, or not, a break away part (8) provided at the cap (2).

3. A lamp as claimed in claim 1, characterized in that the cap (2) comprises a row of break away parts (8), whereby one or more break away parts (8) may be removed.

4. A lamp as claimed in claim 1, characterized in that two break away parts (8) are removed, whereby two separate recesses are created (9).

5. A lamp as claimed in claim 1, characterized in that break away parts (8) are present in a radially extending flange (3) of the cap (2).

6. A method for manufacturing a lamp comprising a burner (1) and a cap (2) to connect the lamp with a lampholder, whereby the shape of the cap (2) determines the type of lampholder to which the lamp can be connected, characterized in that the shape of the cap (2) is established after the burner (1) and the cap (2) are assembled to form the lamp.

7. A method as claimed in claim 6, characterized in that said shape of the cap (2) is established by breaking away a part (8) of the cap (2), whereby that part (8) was connected to the remainder of the cap (2) by a relative weak connection.

8. A method as claimed in claim 6, characterized in that said shape to be established depends on the results of a testing procedure of the lamp.
